(19) United States
(12) Patent Application Publication
(10) Pub. No.: US 2003/0175492 A1
(43) Pub. Date: Sep. 18, 2003

(54) Antistatic polyoxymethylene molding compounds

(76) Inventors: Burkhardt Dames, Heppenheim (DE); Erich Pellkofer, Mutterstadt (DE)

Correspondence Address: KEIL & WEINKAUF, 1350 CONNECTICUT AVENUE, N.W., WASHINGTON, DC, 20036, US

(21) Appl. No.: 10/312,542

(22) PCT Filed: Jun. 22, 2001
(86) PCT No.: PCT/EP01/07131

(30) Foreign Application Priority Data
Jun. 29, 2000 (DE) 100 30 632.2

(51) Int. Cl. B32B 3/26

(52) U.S. Cl. 428/304.4

(57) ABSTRACT

The invention relates to thermoplastic molding compounds, comprising at least (A) 10 to 99.99 wt.-% of a polyoxymethylene homopolymer or copolymer, at least (B) 0.01 to 5 wt.-% of a polyethylenimine homopolymer or copolymer, at least (C) 0.1 to 15 wt.-% of a polyalkylene glycol or polyalkylene glycolamine or the mixtures thereof, (D) 0 to 70 wt.-% of further additives, whereby the sum of the weight percentages of components (A) to (D) always adds up to 100%.

The invention relates to thermoplastic molding compositions comprising at least

A) from 10 to 99.99% by weight of at least one polyoxymethylene homo- or copolymer and at least

B) from 0.01 to 5% by weight of at least one polyethyleneimine homo- or copolymer and at least

C) from 0.1 to 15% by weight of at least one polyalkylene glycol or one polyalkylene glycolamine, or a mixture of these, and

D) from 0 to 70% by weight of other additives,

where the total of the percentages by weight of components A) to D) is always 100%.

The invention further relates to the use of the molding compositions of the invention for producing moldings of any type, and to the resultant moldings of any type.

Many polymers have the disadvantage of a marked capability to become electrostatically charged. Once charges have been applied, low conductivity means that they cannot be dissipated sufficiently rapidly. However, rapid dissipation of charges is frequently required for reasons of safety, as well as for reasons associated with aesthetics and technical reasons associated with applications. If rapid dissipation of charges is not ensured, the results can be soiling of polymer surfaces, electrical charging of persons in contact with polymers, and sparking due to severe charge build-up, followed by ignition of dust/air or solvent/air mixtures.

Further details of antistatic additives and of the mechanism of static charging can be found, for example, in “Plastics Additives Handbook”, editors R. Gächler and H. Müller, Hanser Verlag, 3rd edition, 1990, pp. 749-775.

However, the known substances for increasing volume conductivity, such as carbon black or metal powders, impair the mechanical properties of the polymers and cannot be used for applications, e.g. packaging of microchips, since carbon black can deposit on the sensitive components, resulting in irreversible damage to the component.

Other traditional antistatics, e.g. quarternary ammonium salts irreversibly damage polyoxymethylene.

EP-A 432 888 describes a mixture of fatty esters of polyhydric alcohols and polyethylene glycol as an antistat when a TPU is used at the same time. This causes a reduction in strength, e.g. of the modulus of elasticity, and other mechanical properties.

Polyethyleneimines are likewise known per se and are used in papermaking: they aggregate the paper fibers and bind undesirable minor components, i.e. are used as aggregators and as flocculators and complexers, improving the wet strength of the paper. Polyethyleneimines are also used in the production of colorants and coatings, and for water treatment, and also as adhesive layers in laminated polypropylene composite films, and in the production of petroleum and of natural gas, and finally for immobilizing enzymes. See Ullmann's Encyclopedia of Industrial Chemistry, 6th edn., 1999 Electronic Release, Verlag VCH Weinheim, keyword “Aziridines”, Chap. 6 “Uses” (referred to below as “Ullmann Electronic Release”). The use of polyethyleneimines as a constituent of thermoplastic molding compositions has not hitherto been disclosed.

It is an object of the present invention, therefore, to provide antistatic thermoplastic POM molding compositions whose color properties, thermal stability, and mechanical properties have been very substantively retained.

We have found that this object is achieved by means of the molding compositions defined at the outset. Preferred embodiments are found in the subclaims.

As component A), the molding compositions of the invention comprise from 10 to 99.99% by weight, preferably from 20 to 98.95% by weight, and in particular from 50 to 97.95% by weight, of a polyoxymethylene homo- or copolymer.

Polymers of this type are known per se to the skilled worker and are described in the literature.

These polymers very generally have at least 50 mol % of recurring —CH₂O— units in their main polymer chain.

The homopolymers are generally prepared by polymerizing formaldehyde or trioxane, preferably in the presence of suitable catalysts.

For the purposes of the invention, component A is preferably polyoxymethylene copolymers, especially those which, besides the repeat —CH₂O— units, also have up to 50 mol %, preferably from 0.1 to 20 mol %, in particular from 0.3 to 10 mol %, and very particularly preferably from 2 to 6 mol %, of repeat units

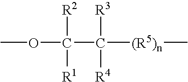

where R¹ to R⁴, independently of one another, are hydrogen, C₁-C₄-alkyl or halogen-substituted alkyl having from 1 to 4 carbon atoms, and R⁵ is —CH₂—, —CH₂O—, C₁-C₄-alkyl- or C₁-C₄-haloalkyl-substituted methylene or a corresponding oxymethylene group, and n is from 0 to 3. These groups may be advantageously introduced into the copolymers by ring-opening of cyclic ethers. Preferred cyclic ethers have the formula

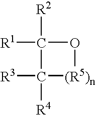

where R¹ to R⁵ and n are as defined above. Mention may be made, merely as examples, of ethylene oxide, propylene 1,2-oxide, butylene 1,2-oxide, butylene 1,3-oxide, 1,3-dioxane, 1,3-dioxolane and 1,3-dioxepane as cyclic ethers, and also linear oligo- and polyformals, such as polydioxolane or polydioxepan as comonomers.

Other suitable components A) are oxymethylene terpolymers, prepared, for example, by reacting trioxane, one of the cyclic ethers described above and a third monomer, preferably bifunctional compounds of the formula

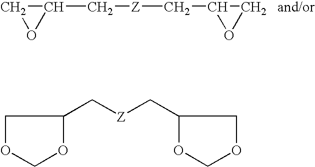

where Z is a chemical bond, —O—, —ORO— (R=C₁-C₈-alkylene or C₂-C₈-cycloalkylene).

Preferred monomers of this type are ethylene diglycide, diglycidyl ether and diethers made from glycidyl compounds and formaldehyde, dioxane or trioxane in a molar ratio of 2:1, and also diethers made from 2 mol of glycidyl compound and 1 mol of an aliphatic diol having from 2 to 8 carbon atoms, for example the diglycidyl ether of ethylene glycol, 1,4-butanediol, 1,3-butanediol, 1,3-cyclobutanediol, 1,2-propanediol or 1,4-cyclohexanediol, to mention merely a few examples.

Processes for preparing the homo- and copolymers described above are known to the skilled worker and described in the literature, and further details are therefore superfluous here.

The preferred polyoxymethylene copolymers have melting points of at least 150° C. and molecular weights (weight-average) M_{W} in the range from 5000 to 200,000, preferably from 7000 to 150,000.

Particular preference is given to end-group-stabilized polyoxymethylene polymers, which have carbon-carbon bonds at the ends of the chains.

According to the invention, as component B), the thermoplastic molding compositions comprise from 0.01 to 5% by weight of at least one polyethyleneimine homo- or copolymer. The proportion of B) is preferably from 0.05 to 1% by weight, and in particular from 0.05 to 0.5% by weight.

For the purposes of the present invention, polyethyleneimines are either homo- or copolymers, obtainable by the processes in Ullmann Electronic Release under the keyword Aziridines or as in WO-A 94/12560, for example.

The homopolymers are generally obtainable by polymerizing ethyleneimine (aziridine) in aqueous or organic solution in the presence of acid-releasing compounds, acids or Lewis acids.

Homopolymers of this type are branched polymers which generally contain primary, secondary and tertiary amino groups in a ratio of about 30%:40%:30%. The distribution of the amino groups can generally be determined by ¹³C NMR spectroscopy.

Comonomers used are preferably compounds having at least two amino functions. Suitable comonomers which may be mentioned as examples are alkylenediamines having from 2 to 10 carbon atoms in the alkylene radical, preferably ethylenediamine or propylenediamine. Other suitable comonomers are diethylenetriamine, triethylenetetramine, tetraethylenepentamine, dipropylenetriamine, tripropylenetetramine, dihexamethylenetriamine, aminopropylethylenediamine and bisaminopropylethylenediamine.

Polyethyleneimines usually have an average molecular weight (weight-average) of from 100 to 3,000,000, preferably from 800 to 2,000,000 (determined by light scattering). The viscosity to ISO 2555 (at 20° C.) is generally within the range from 100 to 200,000 mPas, preferably from 1000 to 100,000 mPas.

Other suitable polyethyleneimines are crosslinked polyethyleneimines obtainable by reacting polyethyleneimines with bi- or polyfunctional crosslinkers having, as functional group, at least one halohydrin, glycidyl, aziridine, or isocyanate unit, or a halogen atom. Examples which may be mentioned are epichlorohydrin, and bischlorohydrin ethers of polyalkylene glycols having from 2 to 100 units of ethylene oxide and/or of propylene oxide, and also the compounds listed in DE-A 19 93 17 20 and U.S. Pat. No. 4,144,123. Processes for preparing crosslinked polyethyleneimines are known, inter alia, from the abovementioned publications, and also EP-A 895 521 and EP-A 25 515.

Grafted polyethyleneimines are also suitable, and the grafting agents used may be any compounds which can react with the amino and/or imino groups of the polyethyleneimines. Suitable grafting agents and processes for preparing grafted polyethyleneimines are found in EP-A-675 914, for example.

Other suitable polyethyleneimines for the purposes of the invention are amidated polymers, usually obtainable by reacting polyethyleneimines with carboxylic acids, their esters or anhydrides, carboxamides, or carbonyl halides. Depending on the proportion of amidated nitrogen atoms in the polyethyleneimine chain, the amidated polymers may subsequently be crosslinked using the crosslinkers mentioned. It is preferable here for up to 30% of the amino functions to be amidated, so that there are still sufficient primary and/or secondary nitrogen atoms available for a subsequent crosslinking reaction.

Alkoxylated polyethyleneimines are also suitable, and are obtainable by reacting polyethyleneimine with ethylene oxide and/or with propylene oxide, for example. These alkoxylated polymers, too, may be subsequently crosslinked.

Polyethyleneimines containing hydroxyl groups, and amphoteric polyethyleneimines (incorporating anionic groups) may be mentioned as other suitable polyethyleneimines of the invention, as may lipophilic polyethyleneimines, which are generally obtained by incorporating long-chain hydrocarbon radicals into the polymer chain. Processes for preparing polyethyleneimines of this type are known to the skilled worker, and it is therefore unnecessary to give further details in this connection.

As component C), the molding compositions of the invention comprise from 0.1 to 15% by weight, preferably from 1 to 8% by weight, and in particular from 2 to 6% by weight, of at least one polyalkylene glycol or one polyalkylene glycolamine, or a mixture of these. Preferred polyalkylene glycols are those of the formula I

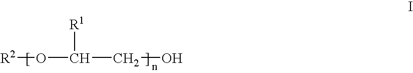

where

R¹ is hydrogen or alkyl having from 1 to 4 carbon atoms, preferably hydrogen and/or methyl,

R² is hydrogen or alkyl having from 1 to 4 carbon atoms, preferably hydrogen and/or methyl, and

n is greater than 2, preferably greater than 30.

Preferred polypropylene glycols are generally obtainable by polyaddition of propylene oxide onto water or onto 1,2-propanediol; polyethylene glycols by base-catalyzed polyaddition of ethylene oxide in systems mostly comprising small amounts of water, with ethylene glycol as starter.

In a broader sense, polyalkylene glycols also include (see Römpps Chemie-Lexikon) products where n=2-4 (di-, tri- and tetraethylene glycol and di-, tri- and tetrapropylene glycols).

For the purposes of the present invention, polyethylene glycols also include alkyl-ethylene oxide/propylene oxide block copolymers, where the blocks may have various arrangements, e.g. A-B-A, B-A-B, or merely 2 A-B blocks. The sequence of adding the monomers determines the block structure.

The polyalkylene glycols generally have OH values to DIN 53240 of from 0.022 to 620 mg KOH/g, preferably from 1 to 170 mg KOH/g.

This usually corresponds to an average molar mass (Mₙ) of from 180 to 5,000,000 g/mol, preferably from 660 to 112,200 g/mol.

Preferred polyethylene glycols have (Mₙ) of from 180 to 50,000, preferably from 500 to 25,000, or an OH value of from 624 to 2.2, preferably from 224 to 4.5.

Preferred polyalkylene glycolamines are generally obtainable by reductive amination of polyalkylene glycols. These usually have an amine value of from 0.5 to 200 mg KOH/g to DIN 53240, preferably from 1 to 150 mg KOH/g, corresponding to an average molecular weight (Mₙ) of from 112,200 to 281, preferably from 56,100 to 374, calculated from the amine value.

As component D), the molding compositions of the invention may comprise from 0 to 70% by weight, preferably from 0 to 30% by weight, of other additives.

Suitable sterically hindered phenols D) are in principle any of the compounds having a phenolic structure and at least one bulky group on the phenolic ring.

Examples of compounds whose use is preferred are those of the formula

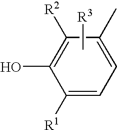

where:

R¹ and R² are alkyl, substituted alkyl or a substituted triazole group, where R¹ and R² may be identical or different, and R³ is alkyl, substituted alkyl, alkoxy or substituted amino.

Antioxidants of the type mentioned are described, for example, in DE-A 27 02 661 (U.S. Pat. No. 4,360,617).

Another group of preferred sterically hindered phenols derives from substituted benzenecarboxylic acids, in particular from substituted benzenepropionic acids.

Particularly preferred compounds of this class have the formula

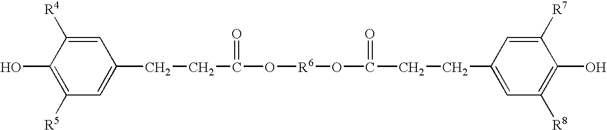

where R⁴, R⁵, R⁷ and R⁸, independently of one another, are C₁-C₈-alkyl which may in turn have substitution (at least one of these is a bulky group) and R⁶ is a bivalent aliphatic radical which has from 1 to 10 carbon atoms and may also have C—O bonds in its main chain.

Preferred compounds having these structures are

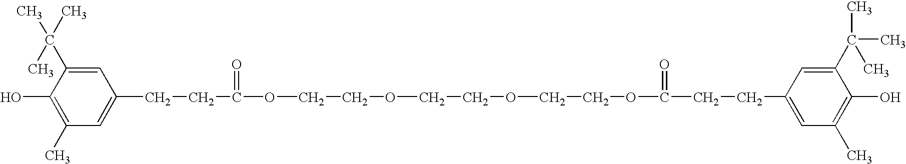

(Irganox® 245 from Ciba-Geigy)

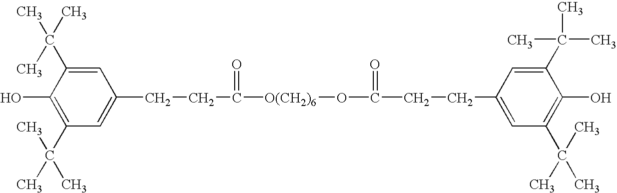

(Irganox® 259 from Ciba-Geigy)

Examples of sterically hindered phenols which may be mentioned are:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]-oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chloro-benzotriazole, 2,6-di-tert-butyl-4-hydroxymethylphenol, 1,3,5-trimethyl-2,4,6-tris(3,5-di-tert-butyl-4-hydroxybenzyl)-benzene, 4,4′-methylenebis(2,6-di-tert-butylphenol), 3,5-di-tert-butyl-4-hydroxybenzyldimethylamine and N,N′-hexamethylenebis-3,5-di-tert-butyl-4-hydroxyhydrocinnamide.

Compounds which have proven especially effective and which are therefore preferably used are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate] and the Irganox® 245 described above from Ciba Geigy, which is particularly suitable.

The amounts present of the antioxidants (D), which may be used individually or as mixtures, are usually up to 2% by weight, preferably from 0.005 to 2% by weight, in particular from 0.1 to 1% by weight, based on the total weight of the molding compositions A) to C).

Sterically hindered phenols which have proven particularly advantageous, in particular when assessing color stability on storage in diffuse light over prolonged periods, in some cases have no more than one sterically hindered group in the ortho position to the phenolic hydroxyl.

The polyamides which can be used as components D) are known per se. Use may be made of partly crystalline or amorphous resins as described, for example, in the Encyclopedia of Polymer Science and Engineering, Vol. 11, John Wiley & Sons, Inc., 1988, pp. 315-489. The melting point of the polyamide is preferably below 225° C., and preferably below 215° C.

Examples of these are polyhexamethylene azelamide, polyhexamethylene sebacamide, polyhexamethylene dodecanediamide, poly-11-aminoundecanamide and bis(p-aminocyclohexyl)methane-dodecanediamide, and the products obtained by ring-opening of lactams, for example, or polylaurolactam. Other suitable polyamides are based on terephthalic or isophthalic acid as acid component and trimethylhexamethylenediamine or bis(p-aminocyclohexyl)propane as diamine component and polyamide base resins prepared by copolymerizing two or more of the abovementioned polymers or components thereof.

Particularly suitable polyamides which may be mentioned are copolyamides based on caprolactam, hexamethylenediamine, p,p′-diaminodicyclohexylmethane and adipic acid. An example of these is the product marketed by BASF Aktiengesellschaft under the name Ultramid® 1 C.

Other suitable polyamides are marketed by Du Pont under the name Elvamide®.

The preparation of these polyamides is also described in the abovementioned publication. The ratio of terminal amino groups to terminal acid groups can be controlled by varying the molar ratio of the starting compounds.

The proportion of the polyamide in the molding composition of the invention is up to 2% by weight, by preference from 0.005 to 1.99% by weight, preferably from 0.01 to 0.08% by weight.

The dispersibility of the polyamides used can be improved in some cases by concomitant use of a polycondensation product made from 2,2-di(4-hydroxyphenyl)propane (bisphenol A) and epichlorohydrin.

Condensation products of this type made from epichlorohydrin and bisphenol A are commercially available. Processes for their preparation are also known to the skilled worker. Trade names of the polycondensates are Phenoxy® (Union Carbide Corporation) and Epikote® (Shell). The molecular weight of the polycondensates can vary within wide limits. In principle, any of the commercially available grades is suitable.

Other stabilizers which may be present in the polyoxymethylene molding compositions of the invention are one or more alkaline earth metal silicates and/or alkaline earth metal glycerophosphates in amounts of up to 2.0% by weight, preferably from 0.005 to 0.5% by weight and in particular from 0.01 to 0.3% by weight, based on the total weight of the molding compositions. Alkaline earth metals which have proven preferable for forming the silicates and glycerophosphates are preferably calcium and, in particular, magnesium. Useful compounds are calcium glycerophosphate and preferably magnesium glycerophosphate and/or calcium silicate and preferably magnesium silicate. Particularly preferable alkaline earth metal silicates are those described by the formula

Me.xSiO₂.nH₂O

where:

Me is an alkaline earth metal, preferably calcium or in particular magnesium,

x is a number from 1.4 to 10, preferably from 1.4 to 6, and

n is a number greater than or equal to 0, preferably from 0 to 8.

The compounds are advantageously used in finely ground form. Particularly suitable products have an average particle size of less than 100 μm, preferably less than 50 μm.

Preference is given to the use of calcium silicates and magnesium silicates and/or calcium glycerophosphates and magnesium glycerophosphates. Examples of these may be defined more precisely by the following characteristic values:

Calcium silicate and magnesium silicate, respectively:

content of CaO and MgO, respectively: from 4 to 32% by weight, preferably from 8 to 30% by weight and in particular from 12 to 25% by weight,

ratio of SiO₂ to CaO and SiO₂ to MgO, respectively (mol/mol): from 1.4 to 10, preferably from 1.4 to 6 and in particular from 1.5 to 4,

bulk density: from 10 to 80 g/100 ml, preferably from 10 to 40 g/100 ml, and and average particle size: less than 100 μm, preferably less than 50 μm.

Calcium glycerophosphates and magnesium glycerophosphates, respectively:

content of CaO and MgO, respectively: above 70% by weight, preferably above 80% by weight

residue on ashing: from 45 to 65% by weight

melting point: above 300° C., and

average particle size: less than 100 μm, preferably less than 50 μm.

Preferred lubricants D) which may be present in the molding compositions of the invention are, in amounts of up to 5 [lacuna], preferably from 0.09 to 2 [lacuna] and in particular from 0.1 to 0.7 [lacuna], at least one ester or amide of saturated or unsaturated aliphatic carboxylic acids having from 10 to 40 carbon atoms, preferably from 16 to 22 carbon atoms, with polyols or with saturated aliphatic alcohols or amines having from 2 to 40 carbon atoms, preferably from 2 to 6 carbon atoms, or with an ether derived from alcohols and ethylene oxide.

The carboxylic acids may be mono- or dibasic. Examples which may be mentioned are pelargonic acid, palmitic acid, lauric acid, margaric acid, dodecanedioic acid, behenic acid and, particularly preferably, stearic acid, capric acid and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol and pentaerythritol, and preference is given to glycerol and pentaerythritol.

The aliphatic amines may be mono- to tribasic. Examples of these are stearylamine, ethylenediamine, propylenediamine, hexamethylenediamine and di(6-aminohexyl)amine, and particular preference is given to ethylenediamine and hexamethylenediamine. Correspondingly, preferred esters and amides are glycerol distearate, glycerol tristearate, ethylenediammonium distearate, glycerol monopalmitate, glycerol trilaurate, glycerol monobehenate and pentaerythritol tetrastearate.

It is also possible to use mixtures of different esters or amides or esters combined with amides, in any desired mixing ratio.

Other suitable compounds are polyether polyols and polyester polyols which have been esterified with mono- or polybasic carboxylic acids, preferably fatty acids, or have been etherified. Suitable products are available commercially, for example Loxiol® EP 728 from Henkel KGaA.

Preferred ethers derived from alcohols and ethylene oxide have the formula

RO(CH₂CH₂O)ₙH

where R is alkyl having from 6 to 40 carbon atoms and n is an integer greater than or equal to 1. R is particularly preferably a saturated C₁₆-C₁₈ fatty alcohol with n≈50, obtainable commercially from BASF as Lutensol® AT 50.

The novel molding compositions may comprise from 0 to 5% by weight, preferably from 0.001 to 5% by weight, particularly preferably from 0.01 to 3% by weight and in particular from 0.05 to 1% by weight, of a melamine-formaldehyde condensate. This is preferably a crosslinked, water-insoluble precipitation condensate in finely divided form. The molar ratio of formaldehyde to melamine is preferably from 1.2:1 to 10:1, in particular from 1.2:1 to 2:1. The structure of condensates of this type and processes for their preparation are found in DE-A 25 40 207.

The novel molding compositions may comprise from 0.0001 to 1% by weight, preferably from 0.001 to 0.8% by weight, and in particular from 0.01 to 0.3% by weight, of a nucleating agent as component D).

Possible nucleating agents are any known compounds, for example melamine cyanurate, boron compounds, such as boron nitride, silica, pigments, e.g. Heliogen® Blue (copper phthalocyanine pigment; registered trademark of BASF Aktiengesellschaft), or branched polyoxymethylenes, which in these small amounts have a nucleating action.

Talc in particular is used as a nucleating agent and is a hydrated magnesium silicate of the formula Mg₃[(OH)₂/Si₄O₁₀] or MgO.4SiO₂.H₂O. This is termed a three-layer phyllosilicate and has a triclinic, monoclinic or rhombic crystal structure and a lamellar appearance. Other trace elements which may be present are Mn, Ti, Cr, Ni, Na and K, and some of the OH groups may have been replaced by fluoride.

Particular preference is given to the use of talc in which 100% of the particle sizes are <20 μm. The particle size distribution is usually determined by sedimentation analysis and is preferably:

| | |
|---|---|
| <20 μm | 100% by weight |
| <10 μm | 99% by weight |
| <5 μm | 85% by weight |
| <3 μm | 60% by weight |
| <2 μm | 43% by weight |

Products of this type are commercially available as Micro-Talc I.T. extra (Norwegian Talc Minerals).

Examples of fillers which may be mentioned, in amounts of up to 50% by weight, preferably from 5 to 40% by weight, are potassium titanate whiskers, carbon fibers and preferably glass fibers. The glass fibers may, for example, be used in the form of glass wovens, mats, nonwovens and/or glass filament rovings or chopped glass filaments made from low-alkali E glass and having a diameter of from 5 to 200 μm, preferably from 8 to 50 μm. After they have been incorporated, the fibrous fillers preferably have an average length of from 0.05 to 1 μm, in particular from 0.1 to 0.5 μm.

Examples of other suitable fillers are calcium carbonate and glass beads, preferably in ground form, or mixtures of these fillers.

Other additives which may be mentioned are amounts of up to 50% by weight, preferably from 0 to 40% by weight, of impact-modifying polymers (also referred to below as elastomeric polymers or elastomers).

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, or mixtures of these. Preference is given to 1,5-hexadiene-5-ethylidenenorbornene [sic] and dicyclopentadiene. The diene content of the EPDM rubbers is preferably from 0.5 bis 50% by weight, in particular from 1 to 8% by weight, based on the total weight of the rubber.

EPDM rubbers may also have been grafted with other monomers, e.g. with glycidyl (meth)acrylates, with (meth)acrylic esters, or with (meth)acrylamides.

Copolymers of ethylene with esters of (meth)acrylic acid are another group of preferred rubbers. The rubbers may also contain monomers having epoxy groups. These monomers having epoxy groups are preferably incorporated into the rubber by adding, to the monomer mixture, monomers having epoxy groups of the formula I or II

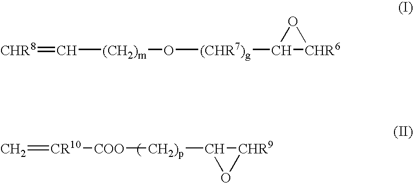

where R⁶ to R¹⁰ are hydrogen or alkyl having from 1 to 6 carbon atoms, and m is an integer from 0 to 20, g is an integer from 0 to 10 and p is an integer from 0 to 5.

R⁶ to R⁸ are preferably hydrogen, where m is 0 or 1 and g is 1. The corresponding compounds are allyl glycidyl ether and vinyl glycidyl ether.

Preferred compounds of the formula II are acrylic and/or methacrylic esters having epoxy groups, for example glycidyl acrylate and glycidyl methacrylate.

The copolymers are advantageously composed of from 50 to 98% by weight of ethylene, from 0 to 20% by weight of monomers having epoxy groups, the remainder being (meth)acrylic esters.

Particular preference is given to copolymers made from

from 50 to 98% by weight, in particular from 55 to 95% by weight, of ethylene, in particular from 0.3 to 20% by weight of glycidyl acrylate, and/or

from 0 to 40% by weight, in particular from 0.1 to 20% by weight, of glycidyl methacrylate, and

from 1 to 50% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Preferred elastomers also include emulsion polymers whose preparation is described, for example, by Blackley in the monograph “Emulsion Polymerization”. The emulsifiers and catalysts which may be used are known per se.

In principle it is possible to use homogeneously structured elastomers or those with a shell structure. The shell-type structure is determined, inter alia, by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, and corresponding methacrylates, and butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). In the case of elastomers having more than one shell it is also possible for more than one shell to be composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible here to use relatively small proportions of other comonomers.

It has proven advantageous in some cases to use emulsion polymers which have reactive groups at their surfaces. Examples of groups of this type are epoxy, amino and amide groups, and also functional groups which may be introduced by concomitant use of monomers of the formula

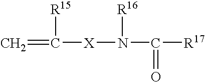

where:

R¹⁵ is hydrogen or C₁-C₄-alkyl,

R¹⁶ is hydrogen, C₁-C₈-alkyl or aryl, in particular phenyl,

R¹⁷ is hydrogen, C₁-C₁₀-alkyl, C₆-C₁₂-aryl or —OR¹⁸

R¹⁸ is C₁-C₈-alkyl or C₆-C₁₂-aryl, if desired with substitution by O- or N-containing groups,

X is a chemical bond, C₁-C₁₀-alkylene or C₆-C₁₂-arylene, or

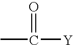

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate, butanediol diacrylate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of those compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers containing allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in component D) is generally up to 5% by weight, preferably not more than 3% by weight, based on D).

Some preferred emulsion polymers are listed below. Mention is made here firstly of graft polymers with a core and with at least one outer shell and the following structure:

| Monomers for the core | Monomers for the envelope |
|---|---|
| 1,3-Butadiene, isoprene, | Styrene, acrylonitrile, |
| n-butyl acrylate, ethylhexyl | (meth)acrylate, where appropri- |
| acrylate or a mixture of these, | ate having reactive groups, as |
| where appropriate together with | described herein |
| crosslinking monomers | |

Instead of graft polymers whose structure has more than one shell it is also possible to use homogeneous, i.e. single-shell, elastomers made from 1,3-butadiene, isoprene and n-butyl acrylate or from copolymers of these. These products, too, may be prepared by concomitant use of crosslinking monomers or of monomers having reactive groups.

The elastomers D) described may also be prepared by other conventional processes, e.g. by suspension polymerization.

Other suitable elastomers which may be mentioned are thermoplastic polyurethanes, as described in EP-A 115 846, EP-A 115 847, and EP-A 117 664, for example.

It is, of course, also possible to use mixtures of the rubber types listed above.

The molding compositions of the invention may also comprise other conventional additives and processing aids. Merely by way of example, mention may be made here of additives for scavenging formaldehyde (formaldehyde scavengers), plasticizers, coupling agents, and pigments. The proportion of additives of this type is generally within the range from 0.001 to 5% by weight.

The molding compositions of the invention may comprise, as component D), and based on the entire weight of components A) to D), from 0 to 2, preferably from 10 ppm to 1.5% by weight, and in particular from 0.001 to 1% by weight, of an alkali metal compound and/or an alkaline earth metal compound.

Use may generally be made of any of the alkaline earth metal cations and/or alkali metal cations, preference being given to lithium cations, sodium cations, potassium cations, and calcium cations.

For the purposes of the present invention, alkali metal compounds and alkaline earth metal compounds are those inorganic or organic salts which give an alkaline reaction in aqueous solution or suspension.

Examples which may be mentioned of inorganic salts are carbonates, hydrogen carbonates, hydroxides, oxides, and phosphates, particular preference being given to alkali metal carbonates, such as potassium carbonate and sodium carbonate.

Examples of organic salts are alcoholates of C₂-C₁₂ alcohols, phenolates, and salts of carboxylic acids having from 2 to 12 carbon atoms, particular preference being given to citrates, oxalates, and tartrates.

Particular preference is given to alkali metal hydroxides, especially potassium hydroxide and sodium hydroxide, which are preferably added in the form of an aqueous solution of from 10 to 70% strength, preferably from 40 to 60% strength, when preparing the POM molding compositions, and these may be metered in together with the carbon black.

The thermoplastic molding compositions of the invention are prepared by mixing the components in a manner known per se, and detailed information in this connection is therefore unnecessary. The components are advantageously mixed in an extruder.

In one preferred form of the preparation, component B), and also, where appropriate, component(s) C) and D) may preferably be applied at room temperature to the pellets of A), followed by extrusion.

In another preferred embodiment, B) is added into the thermoplastic melt A) by means of a solution, preferably an aqueous solution. This usually has a solids content of from 0.005 to 5%, preferably from 0.1 to 1%.

The thermoplastic molding compositions of the invention have a balanced property profile, and also low antistatic [sic] charging, and have very good thermal stability, showing low mold deposit formation, discoloration and formaldehyde emission during processing. Moldings of this type are therefore especially suitable for use as chain links, casters, slide rails, or gearwheels, for example.

### EXAMPLES

The components used were as follows:

Component A)

Polyoxymethylene copolymer made from 97.3% by weight of trioxane and 2.7% by weight of butanediol formal. The product still comprised about 3% by weight of unconverted trioxane and 5% by weight of thermally unstable fractions. Once the thermally unstable fractions had been degraded, the copolymer had an MVR of 2.2 ml/10 min (190° C., 2.16 kg, to ISO 1133/B).

Component B)

Polyethyleneimine with an average molecular weight (M_{w})—determined by light scattering—of 35,000 and a viscosity to ISO 2555 of 14,000 MPas [sic] at 20° C.

Component C)

Polyethylene glycol with an average molecular weight (Mₙ) of 12,000 and an OH value to DIN 53240 of 9.35 mg KOH/g.

Components D

D/1 Irganox® 245 from Ciba Geigy:

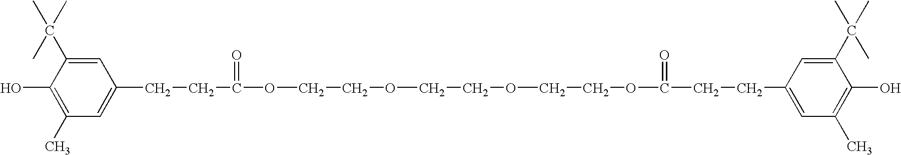

D/2 Polyamide oligomer with a molecular weight of about 3000, prepared from caprolactam, hexamethylenediamine, adipic acid and propionic acid (as molecular weight regulator) by analogy with Examples 5-4 of U.S. Pat. No. 3,960,984 (“PA-dicapped”).

D/3 Synthetic Mg silicate (Ambosol® from Societe Nobel, Puteaux) with the following properties:

| | |
|---|---|
| MgO content | ≧14.8% by weight |
| SiO₂ content | ≧ 59% by weight |
| Ratio Sio₂:MgO | 2.7 mol/mol |
| Bulk density | 20 to 30 g/100 m [sic] |
| Loss on ashing: | <25% by weight |

D/4 A melamine-formaldehyde condensate as in Example 1 of DE-A 25 40 207.

To prepare the molding compositions, component A was mixed with the amounts given in the table of components B to D in a dry-mixer at 23° C. The mixture thus obtained was homogenized in a twin-screw vented extruder at 230° C., and the homogenized mixture was extruded through a die in the form of a strand, and pelletized.

The following were determined to test thermal stability:

WL N₂: weight loss in percent of a specimen of 1.2 g of pellets on heating to 220° C. in nitrogen for 2 hours,

WL air: weight loss in percent of a specimen of 1.2 g of pellets on heating to 220° C. in air for 2 hours.

Antistatic properties were determined by the corona test: W. Hübler, Elektrotechnik 53, Volumes 15/16 (1971) pp. 10-15: Determination of electrostatic behavior via contactless charging. Surface resistance was determined to DIN VDE 0303 T.3 (previously DIN 53482).

Measurements were taken after 3 days' storage under 23/50 standard conditions of temperature and humidity (23° C./50% atmospheric humidity). The symbols here have the following meanings:

Delta E: Fall-off of charge in %

R_{OA}: Surface resistance measured with electrode arrangement A (100 mm*10 mm)

In the tables below component A) means A) comprising, respectively, 0.35% by weight of D/1, 0.04% by weight of D/2, 0.05% by weight of D/3, and 0.2% by weight of D/4.

The makeups of the molding compositions and the results from the measurements are given in Tables 1 to 3.

TABLE 1

| Example | | 1 c | 1 | 2 | 3 |
|---|---|---|---|---|---|
| A | [%] by | 97.00 | 96.90 | 96.85 | 96.80 |
| | weight | | | | |
| C | [%] by | 3.00 | 3.00 | 3.00 | 3.00 |
| | weight | | | | |
| B | [%] by | | 0.10 | 0.15 | 0.20 |
| | weight | | | | |

Analysis

Weight loss:

| | | | | | |
|---|---|---|---|---|---|
| N₂ | [%] | 0.35 | 0.26 | 10.24 | 0.21 |
| Air | [%] | 5.84 | 1.89 | 11.49 | 0.99 |
| MVR | [ml/10 min] | 3.43 | 3.2 | 3.06 | 3.02 |

Antistatic properties measured after 3 days under SC

| | | | | | |
|---|---|---|---|---|---|
| Delta E | [%] | 96 | 100 | 100 | 100 |
| R_{OA} | [Ω] | 2E+12 | 9E+11 | 1E+12 | 5E+11 |

TABLE 2

| Example | | 2c | 4 | 5 | 6 |
|---|---|---|---|---|---|
| A | [% ] by | 96.5 | 96.4 | 96.35 | 96.3 |
| | weight | | | | |
| C | [%] by | 3.50 | 3.50 | 3.50 | 3.50 |
| | weight | | | | |
| B | [%] by | | 0.10 | 0.15 | 0.20 |
| | weight | | | | |

Analysis

Weight loss:

| | | | | | |
|---|---|---|---|---|---|
| N₂ | [%] | 0.32 | 0.20 | 0.18 | 0.13 |
| Air | [%] | | 1.58 | 1.37 | 1.29 |
| MVR | [ml/10 | 2.8 | 12.71 | 2.84 | 2.97 |
| | min] | | | | |

Antistatic properties measured after 3 days under SC

| | | | | | |
|---|---|---|---|---|---|
| Delta E | [%] | 100 | 100 | 100 | 99 |
| R_{OA} | [Ω] | 1E+12 | 1E+12 | 1E+12 | 6E+11 |

TABLE 3

| | | 3 c | 7 | 8 | 9 | 4 c |
|---|---|---|---|---|---|---|
| A | [%] by | 96 | 95.9 | 95.85 | 95.80 | 100.00 |
| | weight | | | | | |
| C | [%] by | 4.00 | 4.00 | 4.00 | 4.00 | |
| | weight | | | | | |
| B | [%] by | 0.1.0 | 0.15 | 0.20 | | |
| | weight | | | | | |

Analysis

Weight
loss:

| | | | | | | |
|---|---|---|---|---|---|---|
| N₂ | [%] | 0.23 | 0.18 | 10.12 | 0.17 | 0.30 |
| Air | [%] | 3.91 | 1.66 | 11.33 | 1.17 | 3.17 |
| MVR | [ml/10 | 4.16 | 2.80 | 3.58 | 3.12 | 2.65 |
| | min] | | | | | |

Antistatic properties measured after 3 days under SC

| | | | | | | |
|---|---|---|---|---|---|---|
| Delta E | [%] | 100 | 97 | 100 | 100 | 92 |
| ROA | [Ω] | 7E+11 | 5E+11 | 5E+11 | 3E+11 | 1E+14 |

We claim:

1. A thermoplastic molding composition comprising
A) from 10 to 99.99% by weight of at least one polyoxymethylene homo- or copolymer,
B) from 0.01 to 5% by weight of at least one polyethyleneimine homo- or copolymer,
C) from 0.1 to 15% by weight of at least one polyalkylene glycol or one polyalkylene glycolamine, or a mixture of these, and
D) from 0 to 70% by weight of other additives,
where the total of the percentages by weight of components A) to D) is always 100%.

2. A thermoplastic molding composition as claimed in claim 1, in which the component B) present comprises polyalkylene glycols of the formula I 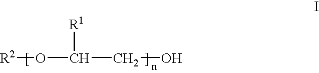
where
R¹ is hydrogen or alkyl having from 1 to 4 carbon atoms,
R² is hydrogen or alkyl having from 1 to 4 carbon atoms, and
n is greater than 2.

3. A thermoplastic molding composition as claimed in claim 1 or 2, comprising from 0.05 to 1% by weight of B).

4. A thermoplastic molding composition as claimed in any of claims 1 to 3, comprising from 1 to 8% by weight of C).

5. A thermoplastic molding composition as claimed in any of claims 1 to 4, where the polyethyleneimine polymers have been selected from
homopolymers of ethyleneimine,
copolymers of ethyleneimine and amines having at least two amino groups,
crosslinked polyethyleneimines,
grafted polyethyleneimines,
amidated polymers obtainable by reacting polyethyleneimines with carboxylic acids or with carboxylic esters, with carboxylic anhydrides, with carboxamides, or with carbonyl halides,
alkoxylated polyethyleneimines,
polyethyleneimines containing hydroxyl groups,
amphoteric polyethyleneimines, and
lipophilic polyethyleneimines.

6. The use of a thermoplastic molding composition as claimed in any of claims 1 to 5 for producing moldings, films, fibers, or foams.

7. A molding, a film, a fiber, or a foam obtainable from a thermoplastic molding composition as claimed in any of claims 1 to 5. Antistatic polyoxymethylene molding compositions Abstract Thermoplastic molding compositions comprise at least
E) [sic] from 10 to 99.99% by weight of one polyoxymethylene homo- or copolymer and at least
F) [sic] from 0.01 to 5% by weight of one polyethyleneimine homo- or copolymer and at least
G) [sic] from 0.1 to 15% by weight of one polyalkylene glycol or one polyalkylene glycolamine, or a mixture of these, and
H) [sic] from 0 to 70% by weight of other additives,
where the total of the percentages by weight of components A) to D) is always 100%.
